(19) United States
(12) Patent Application Publication
(10) Pub. No.: US 2005/0238361 A1
(43) Pub. Date: Oct. 27, 2005

(54) Optical transponder with equipment failure protection

(75) Inventors: Oren Marmur, Kiryat Ono (IL); Joseph Arol, Kiryat Ono (IL); Ido Gur, Rishon Lezion (IL); Benny Maly, Moshav Satariya (IL)

Correspondence Address: Harold L. Novick;NATH & ASSOCIATES PLLC, 6th Floor, 1030 15th Street, N.W., Washington, DC, 20005, US

(73) Assignee: Lightscape Networks Ltd., Petach Tikva (IL)

(21) Appl. No.: 10/994,180

(22) Filed: Nov. 22, 2004

Related U.S. Application Data
(63) Continuation-in-part of application No. 10/271,770, filed on Oct. 17, 2002.
Application No. 10/271,770 is a continuation of application No. PCT/IL01/00343, filed on Apr. 15, 2001.

(30) Foreign Application Priority Data
Apr. 18, 2000 (IL) 135,715

(51) Int. Cl. H04B 10/00

(52) U.S. Cl. 398/140

(57) ABSTRACT

A dual E/O transmitter module optical transponder comprising an E/O receiver module capable of converting an ingressing optical signal from an optical signal source to an electrical signal, a pair of E/O transmitter modules connected in parallel and each capable of converting the electrical signal to an egressing optical signal, a control device for enabling one of the pair of E/O transmitter modules and disabling the other of the pair of E/O transmitter modules, and an optical coupler coupled to the pair of E/O transmitter modules for feeding the egressing optical signal from the enabled E/O transmitter module to an optical signal destination.

### CROSS REFERENCE TO RELATED APPLICATIONS

The present application is a continuation-in-part application of the currently co-pending U.S. application Ser. No. 10/271,770, filed Oct. 17, 2002, which is a National Phase application of International Application Ser. No. PCT/IL01/00343 filed Apr. 15, 2001, which International Application claims priority on Israel Application Ser. No. 135,715 filed Apr. 18, 2000.

### FIELD OF THE INVENTION

The invention is in the field of optical transponders.

### BACKGROUND OF THE INVENTION

Optical ring networks include two optical fibers, one dedicated for adding and dropping working channels and the other dedicated for protection channels. Optical ring networks typically include one or more so called unidirectional optical transponders for adding an optical signal to a working channel or dropping one off therefrom, so called 1×2 add direction optical transponders for adding identical optical signals to the working channel and the protection channel, and so called 2×1 drop direction optical transponders for dropping an optical signal from either the working channel or the protection channel.

### SUMMARY OF THE INVENTION

In accordance with the present invention, there is provided a dual E/O transmitter module optical transponder comprising:
(a) an O/E receiver module capable of converting an ingressging optical signal from an optical signal source to an electrical signal;
(b) a pair of E/O transmitter modules connected in parallel and each capable of converting said electrical signal to an egressing optical signal;
(c) a control device in communication with each E/O transmitting module of said pair for maintaining their performance and for enabling one of said pair of E/O transmitter modules and disabling the other of said pair of E/O transmitter modules; and
(d) an optical coupler coupled to said pair of E/O transmitter modules for feeding said egressing optical signal from said enabled E/O transmitter module towards an optical signal destination,
thereby the transponder keeping itself workable to provide the egressing optical signal towards the destination, even in case of non-satisfactory operation or failure of one of said E/O transmitter modules.

The present invention presents a novel solution to the problem of cessation of data transmission through a conventional unidirectional or drop direction optical transponder having only a single E/O transmitter module in the event of its equipment failure.

Further, the present invention presents a novel solution of an optical transponder with multi-stage equipment failure protection. Different stages of the equipment protection are respectively ensured by the second E/O transmitter module, by the optical coupler connected to the pair of the E/O transmitter modules, by optionally using a pair of O/E receiver modules for producing two electrical signals, and by arranging (for at least one O/E receiver module) a branch of two parallel paths where an electrical signal is checked and monitored in the main path and just conducted in a bypass path. The multi-stage equipment failure protection is ensured by a single control device that controls the transponder equipment. Essential features of the proposed optical transponder will become apparent from the following description and the drawings.

### BRIEF DESCRIPTION OF THE DRAWINGS

In order to understand the invention and to see how it can be carried out in practice, preferred embodiments will now be described, by way of non-limiting examples only, with reference to the accompanying drawings, in which similar parts are likewise numbered, and in which:

FIG. 1 is a schematic representation of a dual E/O transmitter module unidirectional optical transponder; and

FIG. 2 is a schematic representation of a dual E/O transmitter module and dual O/E receiver module drop direction optical transponder.

### DETAILED DESCRIPTION OF THE DRAWINGS

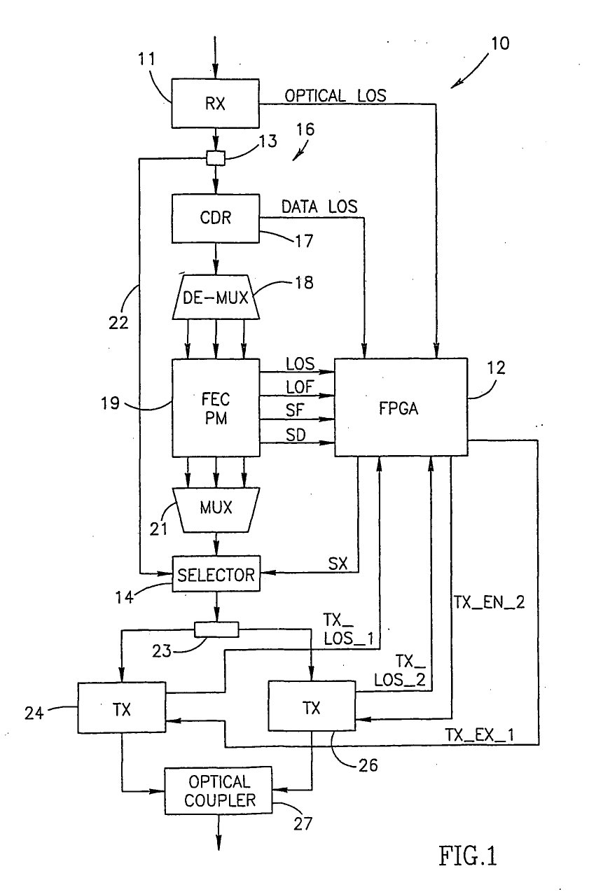

FIG. 1 shows a dual E/O transmitter module unidirectional optical transponder 10 including an optical to electrical (O/E) receiver module 11 coupled to an optical signal source (not shown); a field programmable gate array (FPGA) control device 12; an electrical splitter 13; an electrical selector 14 (constituting a switching device); a main path 16 extending between the splitter 13 and the selector 14 and having a Clock and Data Recovery (CDR) unit 17, a demultiplexer 18, a Forward Error Correction (FEC) and Performance Monitoring (PM) unit 19, and a multiplexer 21; a bypass path 22 (constituted by an electrical shunt) extending between the splitter 13 and the selector 14; a second electrical splitter 23; a pair of E/O transmitter modules 24 and 26 connected in parallel, and an optical coupler 27 coupled to an optical signal destination (not shown).

The O/E receiver module 11 converts an ingressing optical signal to an electrical signal, and provides an optical Loss of Signal (LOS) signal to the FPGA control device 12 in the event that no optical signal is detected thereat. The splitter 13 splits an electrical signal from the O/E receiver module 11 into two identical signals which are respectively fed to the main path 16 and the bypass path 22. The CDR unit 17 performs clock and data recovery on an electrical signal, and provides a data Loss of Signal (LOS) signal to the FPGA control unit 12 in the event that no data signal i.e. a stream of consecutive zeros is detected thereat. The FEC and PM unit 19 performs forward error correction and performance monitoring on an electrical signal, and provides a data Loss of Signal (LOS) signal, a Loss of Frame (LOF) signal, a Signal Fail (SF) signal, and a Signal Degrade (SD) signal to the FPGA control device 12 as appropriate. The control device 12 is also responsible for monitoring performance of the O/E transmitter modules 24 and 26. The selector 14 can feed either an electrical signal from one of the main path 16 or the bypass path 22 to the splitter 23 as determined by an SX signal from the FPGA control device 12. Selection of the bypass path 22 can be caused by a fault in the main path 16, for example due to a signal loss, a failure of any of the signal handling units 17, 18, 19, 21, etc. The splitter 23 splits the electrical signal to two identical signals which are respectively fed to the E/O transmitter modules 24 and 26. The E/O transmitter modules 24 and 26 are capable of being independently enabled by an TX_EN signal from the FPGA control device 12 and can each convert an electrical signal to an egressing optical signal which is fed to the optical coupler 27. The E/O transmitter modules 24 and 26 provide TX_LOS signals to the FPGA control device 12 in the event that they are enabled but no optical signal is detected thereat.

In the default mode of operation of the optical transponder 10, the FPGA control unit 12 switches the selector 23 to feed electrical signals from the main path 16 to the E/O transmitter module 24, and disables the E/O transmitter module 26. In the case of an TX_LOS_1 signal from the E/O transmitter module 24, it is disabled and the E/O transmitter module 26 is enabled. The protection against equipment failure of the E/O transmitter module 24 by the E/O transmitter module 26 is unaffected by the position selection of the selector 23.

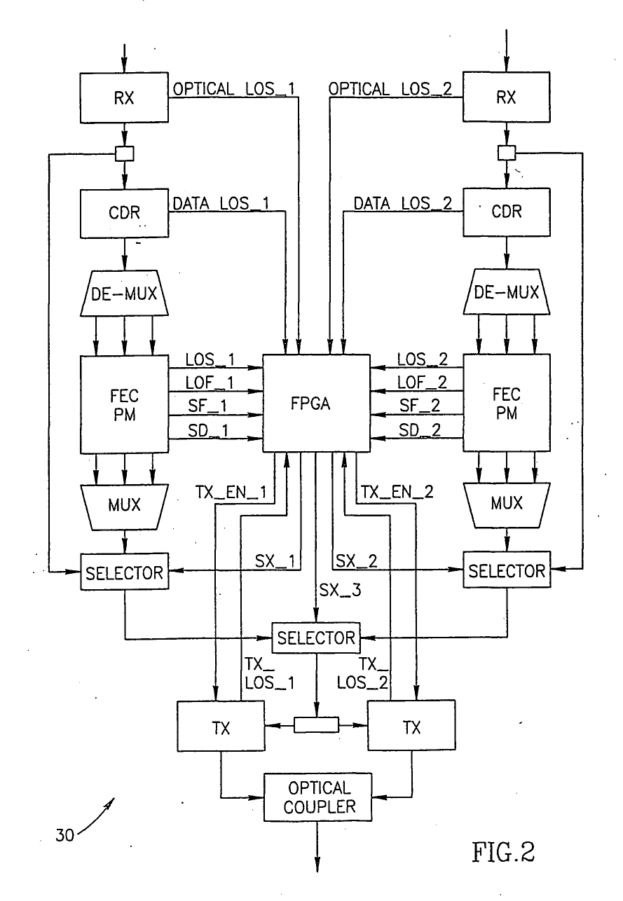

FIG. 2 illustrates another embodiment 30 of the optical transponder, comprising two O/E receiver modules RX that receive a first and a second optical signals and respectively convert thereof into a first and a second electrical signals. The transponder 30 respectively comprises two symmetric parallel branches for handling the first and the second electrical signals generated by the two O/E receiver modules. Each of these branches is similar to the branch of FIG. 1 that comprises paths 16, 22 and a selector 14. Both of the parallel branches in FIG. 2 are monitored by the transponder's common control device (in this example, FPGA). In addition to the functions of the transponder 10 shown in FIG. 1, the transponder 30 is capable of selecting an electrical signal from those four ones available in the two parallel branches for further converting the selected electrical signal into the optical form by an enabled E/O transmitter module. These control functions of the control device are implemented by a command SX_1 to a selector of the first (left) branch, a command SX_2 to the selector of the second (right) branch, and SX_3 to the central selector; the three selectors thus forming a combined switching device. If either of the two O/E receiver modules RX is faulty (i.e., any of them reports OPTICAL LOSS) to the control device, the second of the branches is selected by the FPGA and the transponder becomes equivalent to that shown in FIG. 1. If neither of the receivers RX is faulty/malfunctioning, and neither of the signal handling devices in both of the main paths reports about a problem, the control device may compare the quality of the first electrical signal in the first main path with the quality of the second electrical signal in the second main path based on comparing and processing the service signals, for example those indicated in FIG. 2: DATA LOSS_1, DATA LOSS_2, LOSS_1, LOSS_2, LOF_1, LOF_2, SF_1, SF_2, SD_1, SD_2. The control device may further select the electrical signal with a better quality for further processing. The control device can be configured to operate according to any pre-selected algorithm and/or a predetermined system of defaults for deciding which of the four electrical signals is to be chosen in each specified situation for being fed to the enabled E/O transmitter module. At last, one of the electrical signals conducted via the bypass paths can be selected. The illustrated transponder is thereby characterized by the multi-stage equipment failure protection, though also allows selecting a better quality signal if the equipment is in order. The dual E/O transmitter module optical transponder of FIG. 2 is particularly suitable for implementation as a drop direction optical transponder.

While the invention has been described with respect to a limited number of embodiments, it will be appreciated that many variations, modifications, and other applications of the invention can be made within the scope of the appended claims.

1. An optical transponder comprising:
(a) an O/E receiver module capable of converting an ingressing optical signal from an optical signal source to an electrical signal;
(b) a pair of E/O transmitter modules connected in parallel and each capable of converting said electrical signal to an egressing optical signal;
(c) a control device in communication with each E/O transmitter module of said pair for monitoring their performance and for enabling one of said pair of E/O transmitter modules and disabling the other of said pair of E/O transmitter modules; and
(d) an optical coupler coupled to said pair of E/O transmitter modules for feeding said egressing optical signal from said enabled E/O transmitter module towards an optical signal destination,
thereby the transponder providing the egressing optical signal towards the destination.

2. The transponder according to claim 1 and further comprising a second O/E receiver module for converting a second optical signal to a second electrical signal, and a switching device for switching one of said electrical signals to said enabled E/O transmitter module, wherein said control device is in communication with each of said two O/E receiver modules for detecting malfunction if takes place at any of them and for further controlling the switching device to block the electrical signal fed from the O/E receiver module being not in order,
the transponder is thereby adapted to provide the egressing optical signal towards the destination in case of malfunction of one of said E/O transmitter modules and/or one of the O/E receiver modules.

3. The transponder according to claim 1, comprising a main path and a bypass path for conducting said electrical signal in parallel from said O/E receiver module to a switching device, said main path comprising at least one signal handling unit in communication with said control device; the control device being operative to detect a malfunction if takes place in the main path and to select, for feeding to said enabled E/O transmitter module, either the electrical signal handled in said main path, or the electrical signal transmitted via said bypass path;
the transponder thereby being adapted to keep itself workable to provide the egressing optical signal in case when at least one of the following equipment groups is not in order:
one of said E/O transmitter modules;
one of said O/E receiver modules;
said at least one signal handling unit in the main path.

4. The transponder according to claim 2, comprising a first main path and a first bypass path for conducting said first electrical signal in parallel from said first O/E receiver module to said switching device; the first main path comprising at least one signal handling unit for handling said first electrical signal, being in communication with said control device;
the transponder also comprising a second main path and a second bypass path for conducting said second electrical signal in parallel from said second O/E receiver module to said switching device; the second main path comprising at least one signal handling unit for handling said second electrical signal, being in communication with said control device;
said control device being operative to detect a malfunction and/or estimate a signal quality in the first and second main paths and select, for feeding to the enabled E/O transmitter module, one of the following four electric signals: the first electrical signal from the first main path, the first electrical signal from the first bypass path, the second electrical signal from the second main path, and the second electrical signal from the second bypass path;
thereby the transponder, when being in a regular condition, allows selection of a better quality electrical signal to form the egressing optical signal, while remains workable to provide the egressing optical signal in case of a malfunction of one or more of the following equipment groups:
one of said E/O transmitter modules;
one of said O/E receiver modules,
at least one of the signal handling units in one or both of said main paths.

5. The transponder according to claim 1 wherein the control device is FPGA based.

6. The transponder according to claim 3, wherein said at least one signal handling unit is selected from a list comprising a Clock and Data Recovery (CDR) unit, a Forward Error Correction (FEC) unit and a Performance Monitoring (PM) unit.

7. The transponder according to claim 4, wherein said at least one signal handling unit is selected from a list comprising a Clock and Data Recovery (CDR) unit, a Forward Error Correction (FEC) unit and a Performance Monitoring (PM) unit.
